(19) United States
(12) Patent Application Publication
(10) Pub. No.: US 2011/0125808 A1
(43) Pub. Date: May 26, 2011

(54) CONSTRUCTION INFORMATION MANAGEMENT DEVICE AND CONSTRUCTION INFORMATION MANAGEMENT SYSTEM

(75) Inventors: Teruo Minamisawa, Yokohama-shi (JP); Youichiro Yamada, Itabashi-ku (JP)

(73) Assignee: PASCO CORPORATION, Tokyo (JP)

(21) Appl. No.: 13/054,328

(22) PCT Filed: Jul. 15, 2009
(86) PCT No.: PCT/JP2009/003331

§ 371 Date: Jan. 14, 2011

(30) Foreign Application Priority Data
Jul. 17, 2008 (JP) 2008-185988

(51) Int. Cl. G06F 7/00

(52) U.S. Cl. 707/803; 707/E17.044; 707/E17.005

(57) ABSTRACT

A construction information management device and a construction information management system can readily grasp the history information about each layer below the surface of a road on which construction has been repeatedly carried out. After a subject construction is finished, a user creates the construction information about the subject construction in a construction information processing terminal, and the construction information is transmitted to a construction information management device. The construction information management device receives the construction information, and, based on the construction information, analyzes the pavement structure of the construction zone. Based on the analyzed construction information, the construction information management device also updates the history information about the construction subject road in a superimposing manner. When a request signal for requesting the history information is transmitted from the construction information processing terminal, the construction information management device transmits the updated history information to the construction information processing terminal.

### BACKGROUND

1. Technical field

The present invention relates to a construction information management device and a construction information management system for managing the information about the construction histories of roads and the like.

2. Related art

A technique for managing objects with the use of IC tags has been suggested. For example, Japanese Patent Laid-Open No. 2007-163962 discloses a technique by which management information about optical fibers, wires and pipes buried under the ground, road facilities, and the like, as the objects to be managed, is stored in IC tags, the management information is read out and referred to by an IC tag reader/writer when construction is carried out on the objects to be managed, and the management information is updated by the IC tag reader/writer when construction is completed.

With the above described conventional technique, it is difficult to accurately grasp the construction histories of the respective layers, under the road surface, arranged in a complicated manner in a case where construction is repeatedly carried out on a specific zone of a road over a number of years, for example.

The present invention has been made in view of the above circumstances, and the object thereof is to provide a construction information management device and a construction information management system that can readily grasp history information about the respective layers under the road surface of a road on which construction has been repeatedly carried out.

### SUMMARY

According to an aspect of the invention, there is provided a construction information management device including: a construction information receiving unit that receives construction information; a pavement structure analyzing unit that analyzes a pavement structure, based on the construction information; a history information obtaining unit that obtains history information about the pavement structure; and a history information updating unit that updates the history information in a superimposing manner, based on a result of the analysis carried out by the pavement structure analyzing unit.

### BRIEF DESCRIPTION OF THE DRAWINGS

Exemplary embodiments of the present invention will be described in detail based on the following figures, wherein:

FIG. 1 is a diagram showing an example structure of an embodiment of a construction information management system;

FIG. 2 is a diagram showing an example structure of a construction information processing terminal;

FIG. 3 is a diagram showing an example of the hardware structure of a computer that forms a construction information management device and the like;

FIG. 4 is a functional block diagram of an embodiment of the construction information management device;

FIG. 5 is a diagram showing an example of construction information;

FIG. 6 is a flowchart of an example operation of the construction information management system;

FIGS. 7(a) and 7(b) are diagrams for explaining an operation to update history information, using part of the history information;

FIG. 8 is a diagram for explaining a construction zone in which construction has been repeatedly carried out;

FIG. 9 is a flowchart of another example operation of the construction information management system.

### DETAILED DESCRIPTION

The following is a description of the exemplary embodiment (hereinafter referred to as an embodiment) for carrying out the invention, with reference to the accompanying drawings.

First, an operation to collect respective pieces of construction information and combine them with construction information gathered in the past then update history information is described.

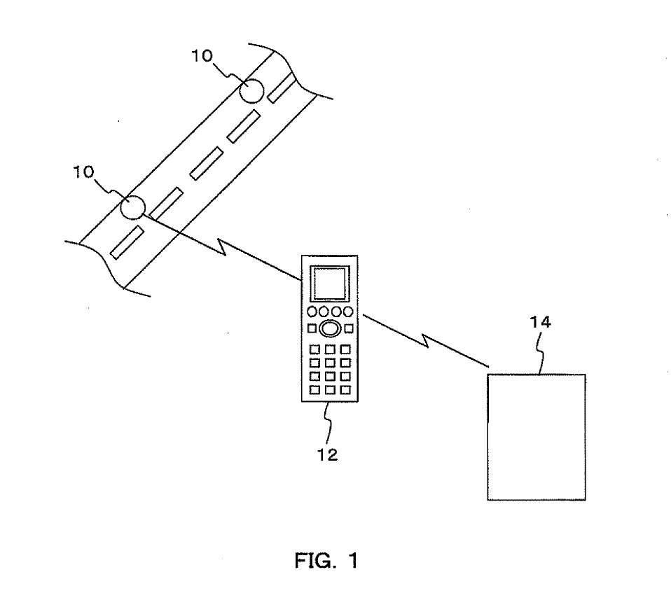

FIG. 1 shows an example structure of an embodiment of a construction information management system. In FIG. 1, the construction information management system includes information holding devices 10, a construction information processing terminal 12, and a construction information management device 14.

The information holding devices 10 are formed by IC tags (RFIDs) or the like, and information about a construction (construction information) event, such as the specifics of the construction and the zone of the construction, is written in those IC tags. The IC tags can be placed at the starting point and the ending point of the road construction zone, or at any points within or outside the construction zone. For example, the IC tags can be provided on metal rivets buried in a road. Each of the information holding devices 10 holds identification information. As the identification information, “ucode (a registered trademark)” may be used, for example. Further, installment location information indicating the installment locations of the metal rivets can be stored as part of the construction information or separately from the construction information in the information holding devices 10. The installation location information may be latitude/longitude information or distances from the starting point of the road (a distance mark). Alternatively, the installation location information may be a code equivalent to the latitude/longitude information or the distance mark. Having the installation location information, the information holding devices 10 can be used as distance marks. Alternatively, only one information holding device 10 in which the starting and ending points of the road construction zone are written and stored as the zone information for identifying the construction zone may be provided at the starting or ending point of the road construction zone, or at any location within the road construction zone.

The construction information processing terminal 12 functions as a reader/writer that writes the construction information, the installation location information, and the like into the information holding devices 10, and reads the information from the information holding devices 10. The construction information processing terminal 12 also has a communication function that transmits the construction information and the like to the construction information management device 14 via an appropriate communication means, and receives history information about the pavement structure of the road or the like from the construction information management device 14.

The construction information management device 14 operates on an appropriate computer. The construction information management device 14 receives the construction information from the construction information processing terminal 12, and updates the history information about the construction. The construction information management device 14 also transmits the history information in response to a request from the construction information processing terminal 12. Here, the history information is the information about the present state (the pavement structure or the like) of the road as the result of construction carried out in the past. The history information may also contain the construction information including the dates of construction carried out in the past. A history information request from the construction information processing terminal 12 is made by transmitting location information for identifying the history information to the construction information management device 14. As the location information, the installation location information or the like in the information holding devices 10 can be used. The location information will be described later in detail. Also, storage information about the storage locations of media such as paper or CD-ROMs on which the construction information about pavement construction or the like carried out in the past is written is stored in the construction information management device 14, and the construction information management device 14 is preferably set up to transmit the storage information in response to a request from the construction information processing terminal 12. With this arrangement, the media in which the construction information about the past pavement construction or the like that has been managed by different firms and local governments is written can be readily managed.

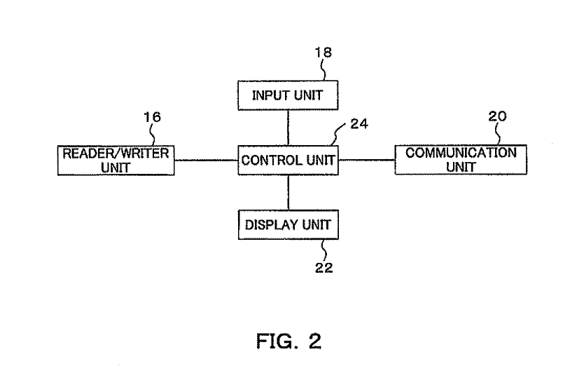

FIG. 2 shows an example structure of the construction information processing terminal 12. In FIG. 2, the construction information processing terminal 12 includes a reader/writer unit 16, an input unit 18, a communication unit 20, a display unit 22, and a control unit 24.

The reader/writer unit 16 writes and reads the construction information, the installation location information, and the like into and from the information holding devices 10 formed by IC tags or the like. In this case, the reader/writer unit 16 exchanges information with the information holding devices 10 through noncontact short-distance wireless communications. By doing so, the reader/writer unit 16 can readily read the construction information held by the information holding devices 10 in an actual site, and can also perform writing on the information holding devices 10. The installation location information can be determined with the use of a GPS, for example, or can be determined based on a road register or the like. However, the installation location information may be determined by some other method.

The input unit 18 is formed by a keyboard or the like, and is used by a user to input an instruction, information, or the like to the construction information processing terminal 12. Also, the input unit 18 can be used to input the installation location information that a user obtained from a road register or the like.

The communication unit 20 is formed by a suitable communication interface, and exchanges data with the construction information management device 14. By virtue of this communication unit 20, the construction information processing terminal 12 can function as a means to transmit the construction information to the construction information management device 14, a means to transmit the location information for identifying history information to the construction information management device 14, a means to receive history information from the construction information management device 14, and a means to receive the storage information about the storage locations of the media in which the past construction information is written from the construction information management device 14. The communication unit 20 may also function as a GPS receiver, and may be designed to acquire the installation location information.

The display unit 22 is formed by a liquid crystal display (LCD) or the like, and displays the construction information, the history information about construction, pavement structure information, and the like.

The control unit 24 includes a central processing unit (a CPU, for example) and a program for controlling the processing operation of the CPU, and controls the operations of the above described respective components.

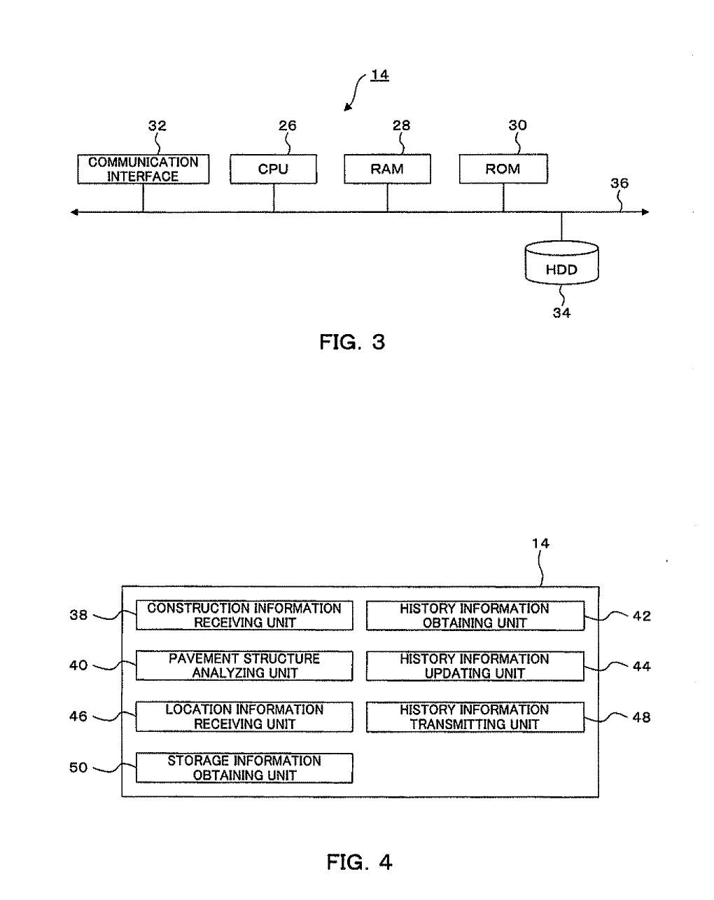

FIG. 3 shows an example of the hardware structure of the computer forming the construction information management device 14 and the like. In FIG. 3, the construction information management device 14 includes a central processing unit (a CPU, for example) 26, a random access memory (RAM) 28, a read-only memory (ROM) 30, a communication interface 32, and a hard disk drive (HDD) 34. Those components are connected to one another by a bus 36.

The CPU 26 controls the later described operations of the respective components, based on a control program stored in the RAM 28 or the ROM 30. The RAM 28 functions mainly as a work area of the CPU 26, and a control program such as BIOS and other data to be used by the CPU 26 are stored in the ROM 30.

The communication interface 32 is formed by a USB (Universal Serial Bus) port, a network port, and other suitable interfaces, The communication interface 32 is used by the CPU 26 to exchange data with an external device via a communication means such as a network.

The hard disk drive 34 is a storage device, and can store various kinds of data required in the later described operations.

FIG. 4 is a functional block diagram of an embodiment of the construction information management device 14. In FIG. 4, the construction information management device 14 includes a construction information receiving unit 38, a pavement structure analyzing unit 40, a history information obtaining unit 42, a history information updating unit 44, a location information receiving unit 46, a history information transmitting unit 48, and a storage information obtaining unit 50. Those functions are realized by the CPU 26 and the program for controlling the processing operation of the CPU 26.

The construction information receiving unit 38 receives the construction information transmitted from the construction information processing terminal 12 via the communication interface 32. Here, the construction information contains the date of the construction (the construction schedule), the name of the route, the locations of the starting and ending points of the road construction zone, the specifics of the construction, the identification numbers of the information holding devices 10 provided in the actual site, and the like.

The pavement structure analyzing unit 40 analyzes the pavement structure of the zone in which the construction has been carried out, based on the construction information received by the construction information receiving unit 38. Here, the pavement structure is the information about the specifics (the materials, the thicknesses, and the like) of the respective layers that form a paved road or the like and exist under the road surface, such as a surface course, a binder course, a base course, a subbase course, and a filter course.

The history information obtaining unit 42 obtains construction history information that is stored in the hard disk drive 34 or the like, and is about the roads on which construction has been carried out. The history information may be stored at a different location (computer) from the computer in which the construction information management device 14 is provided. In that case, the history information obtaining unit 42 is designed to obtain the history information from the different storage via the communication interface 32.

The history information updating unit 44 updates the history information in a superimposing manner, based on the results of the analysis carried out by the pavement structure analyzing unit 40. Here, “superimposing” means overwriting the construction information about a construction newly carried out in the construction information about the past construction events. That is, in the history information about the past construction, the information about construction in the zone that is the same as the zone of the construction newly carried out is replaced with the construction information about the construction newly carried out. in this manner, the state such as the pavement structure or the like of the road after the construction can be reflected in the history information.

The location information receiving unit 46 receives the location information (such as the latitude/longitude information and the distance marks) for identifying the history information, transmitted from the construction information processing terminal 12, via the communication interface 32. The received location information is transferred to the history information transmitting unit 48 and the storage information obtaining unit 50.

Upon receipt of the location information, the history information transmitting unit 48 obtains the history information identified by the location information, and transmits the history information to the construction information processing terminal 12 via the communication interface 32. The method of identifying the history information will be described later.

Upon receipt of the location information, the storage information obtaining unit 50 obtains the storage information about the storage location of the medium in which the information about the past construction in the construction zone identified by the location information is written, and transmits the storage information to the construction information processing terminal 12 via the communication interface 32. The storage information may be stored in the hard disk drive 34, or may be stored in a different place (a different computer) from the computer in which the construction information management device 14 is provided.

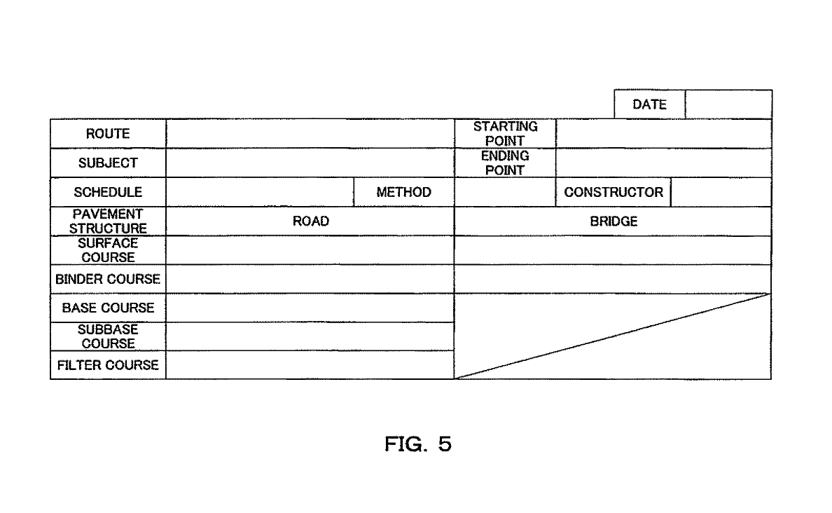

FIG. 5 shows an example of the construction information. In FIG. 5, the construction information contains the route on which the construction was carried out, the starting and ending points of the construction, the subject, the construction schedule, the construction method, the constructor, and the pavement structure. The pavement structure is divided into a road part and a bridge part, and the surface course and the binder course are common pavement components between the two parts. The base course, the subbase course, and the filter course are pavement components only for the road part. It should be noted that the construction information is not limited to the example shown in FIG. 5.

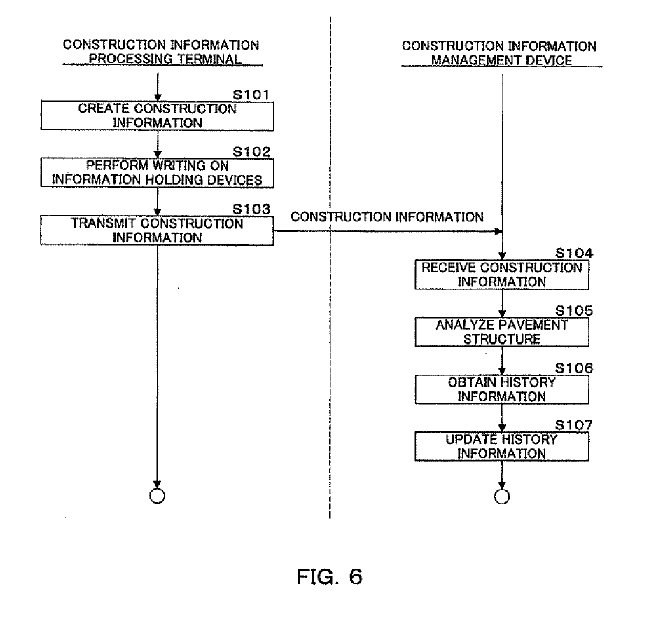

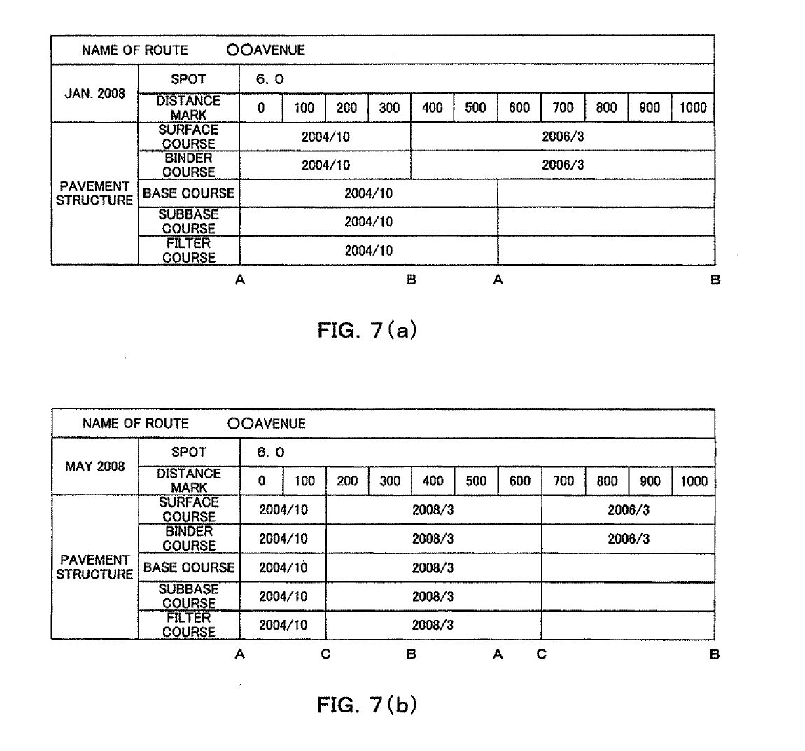

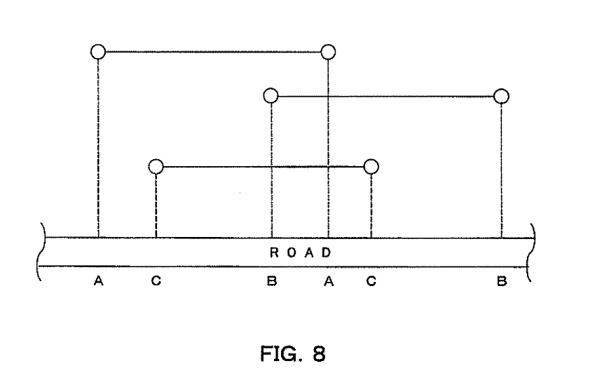

FIG. 6 is a flowchart of an operation of the construction information management system according to this embodiment. FIGS. 7(a) and 7(b) are diagrams for explaining an operation to update the history information, using part of the history information. FIG. 8 is a diagram for explaining a construction zone where constructions have been carried out in a superimposed manner.

In FIGS. 7(a) and 7(b), the dates on which construction was carried out on the five layers of the surface course, the binder course, the base course, the subbase course, and the filter course as the pavement components are recorded for each subject road zone indicated by the distance marks. Those dates are associated with the construction information shown in FIG. 5. In a preferred example, when one of the dates displayed as a list on the screen of the construction information processing terminal 12 is clicked, the corresponding construction information appears on the screen.

FIG. 8 shows an example case where construction is carried out in a zone C-C after construction has already been carried out in a zone A-A and a zone B-B. In this embodiment, an operation to update the history information based on the situation shown in FIG. 8 is described. FIG. 7(a) reflects the construction carried out in the zone A-A and the zone B-B shown in FIG. 8. That is, the zone A-A is the zone indicated by the distance mark 0-500 m, and the zone B-B is the zone indicated by the distance mark 400-1000 m. As can be seen from FIG. 7(a), the construction has been carried out on all the five layers in the zone A-A, and the construction has been carried out on the surface course and the binder course in the zone B-B, which has a different pavement structure from the zone A-A in that aspect. In FIG. 7(b), the zone C-C shown in FIG. 8 is superimposed on the situation shown in FIG. 7(a). That is, the zone C-C is the zone indicated by the distance mark 200-600 m. In the zone C-C, the construction has been carried out on all the five layers, and the pavement structure in that part has been overwritten. As a result, the pavement structure in the zone C-C differs from that in the zone A-A and the zone B-B. In this manner, the history information contains the information about the spots or zones over which the pavement structure has discontinuity as a result of construction.

In FIG. 6, after construction (hereinafter referred to as the subject construction), a user creates the construction information about the subject construction in the construction information processing terminal 12 (S101). The construction information has the contents shown in FIG. 5, and can be created by inputting predetermined information through the input unit 18 with the use of an appropriate user interface displayed on the display unit 22 of the construction information processing terminal 12. The created construction information is written into the information holding devices 10 provided at the starting and ending points and the like of the subject construction by the reader/writer unit 16 of the construction information processing terminal 12 (S102).

The construction information is also transmitted to the construction information management device 14 by the communication unit 20 of the construction information processing terminal 12 (S103). The construction information is then received by the construction information receiving unit 38 of the construction information management device 14 (S104).

Based on the construction information received by the construction information receiving unit 38, the pavement structure analyzing unit 40 analyzes the pavement structure (S105). The history information obtaining unit 42 obtains the construction history information about the road subjected to the construction from the hard disk drive 34 or some other location (S106). As shown in FIG. 7(a), the history information contains the information about the pavement structure of each construction zone as a result of each construction event carried out in the past. Therefore, based on the construction information about the subject construction analyzed by the pavement structure analyzing unit 40, the history information updating unit 44 updates the history information in a superimposing manner (S107). Here, “updating in a superimposing manner” means overwriting the history information about the zone corresponding to the subject construction with the construction information about the subject construction.

According to the history information obtained by the history information obtaining unit 42 in this embodiment, construction was carried out in the zone A-A and the zone B-B prior to the subject construction (as of January, 2008), as shown in FIGS. 7(a) and 8. The subject construction was then carried out in the zone C-C, and the construction information about the subject construction was created by the construction information processing terminal 12. As can be seen from the results of the analysis carried out by the pavement structure analyzing unit 40, the subject construction was carried out on the five layers of the surface course, the binder course, the base course, the subbase course, and the filter course. Accordingly, the history information updating unit 44 overwrites the history information about the zone C-C (the zone indicated by the distance mark 200-600 m) with the construction information about the subject construction, as shown in FIG. 7(b). In this manner, the history information updating unit 44 performs an operation to update the information about a spot or a zone where the pavement structure is discontinuous due to construction, based on the history information.

Next, an operation to refer to the history information about construction at an intended location on a road is described.

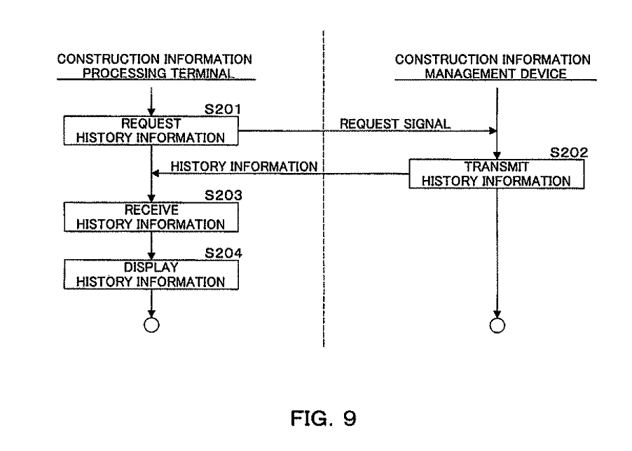

FIG. 9 is a flowchart of another example operation of the construction information management system according to this embodiment. In the operation shown in FIG. 9, the construction information processing terminal 12 refers to the construction history information.

In FIG. 9, the construction information processing terminal 12 transmits the location information about a spot on a road for which a reference is demanded as a request signal to the construction information management device 14 (S201). The location information is directly measured with the use of a GPS, or is estimated from the location of a cellular phone base station. Alternatively, the location information may be read from the information holding devices 10 storing the installation location information. Further, the location information such as addresses and distance marks may be directly input through the input unit 18.

The location information receiving unit 46 of the construction information management device 14 receives the request signal, and transfers the request signal to the history information transmitting unit 48. The history information transmitting unit 48 identifies the location about which the history information is requested, from the location information contained in the request signal. In the example shown in FIGS. 7(a) and 7(b), the history information is identified by identifying a spot on the road with the use of the location information as the distance mark, for example, and obtaining the pavement structure or the history information at the spot. Here, a table that associates the location information with the values of distance marks may be created in advance, and the history information may be identified based on this table. Alternatively, a table that associates the dates shown in FIGS. 7(a) and 7(b) with the location information may be used. The history information transmitting unit 48 obtains the above identified history information from a storage location such as the hard disk drive 34 or the like, and transmits the history information to the construction information processing terminal 12 via the communication interface 32 (S202).

The construction information processing terminal 12 receives the updated history information (S203), and the display unit 22 displays the history information on its screen (S204).

Although the exemplary embodiments of the invention have been described above, many changes and modifications will become apparent to those skilled in the art in view of the foregoing description which is intended to be illustrative and not limiting of the invention defined in the appended claims.

1. A construction information management device comprising:
a construction information receiving unit that receives construction information;
a pavement structure analyzing unit that analyzes a pavement structure, based on the construction information;
a history information obtaining unit that obtains history information about the pavement structure; and
a history information updating unit that updates the history information in a superimposing manner, based on a result of the analysis carried out by the pavement structure analyzing unit.

2. The construction information management device according to claim 1, wherein
based on the history information, the history information updating unit updates information about a spot or a zone where a pavement structure is discontinuous due to respective construction.

3. A construction information management system comprising:
the construction information management device according to claim 1, and
a construction information processing terminal that includes:
a location information obtaining unit that obtains location information for identifying the history information;
a location information transmitting unit that transmits the location information to the construction information management device; and
a history information receiving unit that receives the history information from the construction information management device, the history information being identified by the location information.

4. The construction information management system according to claim 3, further comprising
at least one information holding unit that is installed near a construction zone, and holds the construction information about a subject construction.

5. The construction information management system according to claim 4, wherein the construction information contains zone information for identifying the construction zone.

6. The construction information management system according to claim 4, wherein the information holding unit stores installation location information indicating an installation location of the information holding unit.

7. The construction information management system according to claim 4, wherein the construction information processing terminal further includes a construction information reading unit that reads the construction information from the information holding unit.

8. The construction information management system according to claim 3, wherein
the construction information management device further includes a storage information obtaining unit that obtains storage information about a storage location of a medium in which the construction information about construction carried out in the past in the construction zone identified by the location information is written, and
the construction information processing terminal further includes a storage information receiving unit that receives the storage information from the construction information management device.
